(19) United States
(12) Patent Application Publication
(10) Pub. No.: US 2026/0124682 A1
(43) Pub. Date: May 7, 2026

(54) Powder Dispersion and Containment System for Additive Manufacturing Print Cartridge

(71) Applicant: Seurat Technologies, Inc., Wilmington, MA (US)

(72) Inventors: Evan Warniers, Newton, MA (US); Joseph Gillespie, Boxford, MA (US); Brendan Gallahue, Leominster, MA (US)

(21) Appl. No.: 19/379,388

(22) Filed: Nov. 4, 2025

Related U.S. Application Data
(60) Provisional application No. 63/716,493, filed on Nov. 5, 2024.

(51) Int. Cl. B22F 12/60; B22F 12/52; B33Y 10/00; B33Y 40/10

(52) U.S. Cl. CPC B22F 12/60; B22F 12/52; B33Y 10/00; B33Y 40/10

(57) ABSTRACT

A method and an assembly of a powder dispersion mechanism in a powder bed fusion manufacturing assembly that enables efficient powder use, flow, and dispersion. In one embodiment a powder dispersion assembly can include a print cartridge coupled to a powder dispersion assembly. A powder hopper is configured to contain a powder positioned below the print cartridge and have a conveyance mechanism configured to convey the powder from the powder hopper to a powder dispersion mechanism. Dispersed powder is directed to a build plate. The assembly can be configured to disperse powder evenly on a print plate to improve metallurgical properties of a part to be manufactured. Excess powder can be recaptured and reintroduced into the system to improve overall efficiency of the system

### RELATED APPLICATION

The present disclosure is part of a non-provisional patent application claiming the priority benefit of U.S. Patent Application No. 63/716,493, filed on November 5, 2024, which is hereby incorporated by reference in its entirety.

### TECHNICAL FIELD

The present disclosure generally relates to a system and method for high throughput additive manufacturing. In one embodiment powder bed fusion manufacturing is supported by use of discrete print cartridges that support powder dispersion and confinement mechanisms and methods.

### BACKGROUND

Traditional component machining often relies on removal of material by drilling, cutting, or grinding to form a part. In contrast, additive manufacturing, also referred to as 3D printing, typically involves sequential layer by layer addition of material to build a part. Beginning with a 3D computer model, an additive manufacturing system can be used to create complex parts from a wide variety of materials.

One additive manufacturing technique known Powder Bed Fusion Additive Manufacturing (PBF-AM) uses one or more focused lasers to draw a pattern in a thin layer of powder by melting the powder and bonding it to the layer below to gradually form a 3D printed part. Powders can be plastic, metal, glass, ceramic, crystal, other meltable material, or a combination of meltable and unmeltable materials (i.e. plastic and wood or metal and ceramic).

During the additive manufacturing process, powder can be dosed in a discrete fashion and then spread to provide sufficient material for each layer. In modular systems where the print takes place within a sealed cartridge, the cartridge must be dosed with powder. For best results, the dosing process requires relatively even dispersion of the powder, reliable control of the flow of powder, and minimization of mechanical disruption of the system by errant powder.

### SUMMARY

In one embodiment a powder dispersion assembly can comprise a print cartridge configured to couple to a powder dispersion assembly. A powder hopper can be configured to contain a powder below the print cartridge and a conveyance mechanism configured to convey the powder from the powder hopper to a powder dispersion mechanism coupled to the conveyance mechanism. In one embodiment a method of powder conveyance can include providing a powder from a powder hopper to a powder dispersion plate above the powder hopper, dispersing the powder to a conveyance using the powder dispersion plate, conveying the powder to a build plate, and measuring an amount of powder.

### BRIEF DESCRIPTION OF DRAWINGS

Non-limiting and non-exhaustive embodiments of the present disclosure are described with reference to the following figures, wherein like reference numerals refer to like parts throughout the various figures unless otherwise specified.

FIG. 1 illustrates an embodiment of the auger and driving mechanisms of the powder dispersion assembly;

FIG. 2A illustrates a cross-sectional view of an embodiment of the loading of a shuttle of a powder dispersion assembly with powder from a powder hopper;

FIG. 2B illustrates a cross-sectional view of an embodiment of a shuttle loading a ram of a powder dispersion assembly;

FIG. 2C illustrates a cross-sectional view of an embodiment of the spreader assembly actuating a ram to convey a precise dose of powder to the print plane for spreading.

FIG. 3A illustrates a cross-sectional view of an embodiment of a connection of an auger and a dispersion plate;

FIG. 3B illustrates a top view of an embodiment of a powder dispersion plate auger connection;

FIG. 3C illustrates a cross-sectional top view of an embodiment of an assembly comprising an auger wherein the auger has a stationary central screw and a rotatable casing;

FIG. 3D illustrates an embodiment of an exterior of an auger configured to interact with a stationary screw and an embodiment of the exterior casing coupling a driving mechanism;

FIG. 3E illustrates an additive manufacturing system able to provide one or two dimensional light beams to a print bed that can be used in conjunction with powder dispersion assembly embodiments described herein;

FIG. 4 illustrates a method of operating a print bed based additive manufacturing system able to provide one or two dimensional laser light beams that can be used in conjunction with powder dispersion assembly embodiments described herein; and

FIG. 5 illustrates an additive manufacturing system that includes a switchyard system enabling use of multiple print beds and reuse of patterned two-dimensional energy and that can be used in conjunction with the powder dispersion assembly embodiments described herein.

### DETAILED DESCRIPTION OF DRAWINGS

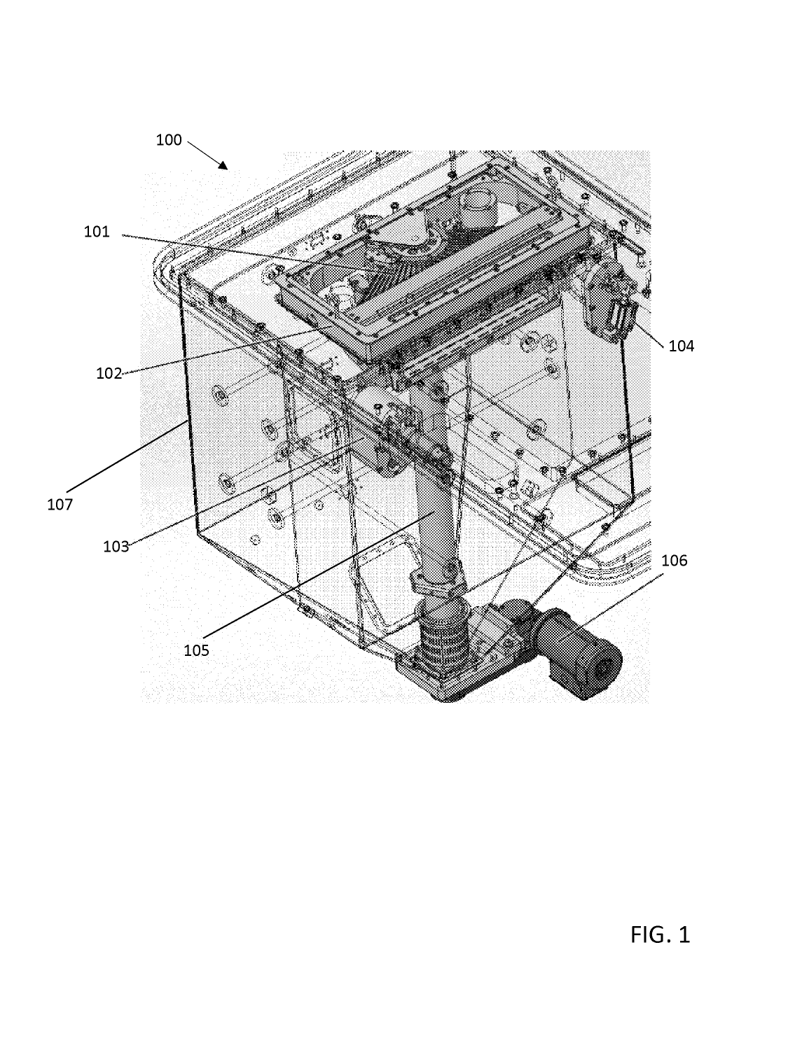

FIG. 1 illustrates an embodiment of a powder dispersion assembly 100 that has a powder dispersion plate, an auger, and a driving mechanisms for the powder dispersion assembly 100. The assembly 100 can include a powder dispersion plate 101, a shuttle mechanism 102 coupled to a shuttle drive cylinder 103, a ram retract 104, and an auger 105 coupled to an auger drive 106. The shuttle 102 can be driven by a shuttle drive 103. In some embodiments the shuttle drive can comprise an electric cylinder, a pneumatic cylinder, and/or any other drive mechanism.

In some embodiments the assembly 100 can be oriented under a print plate positioned within a print cartridge to allow self-contained and quick interchange printing operation within a 3D printer. Additionally, the assembly 100 can include a chamber 107 that can include a powder collection mechanism configured to couple to a powder recycling and recirculation mechanism.

In some embodiments powder dispersion plate 101 can be configured to receive powder from a powder hopper 107 located above or below the powder dispersion plate 101. In various embodiments the powder hopper can be designed to hold a high volume of powder, with the powder hopper being located below the powder bed to reduce mechanical stress due to the weight of the powder contained in the powder hopper and to increase the efficiency and simplicity of refilling the powder hopper.

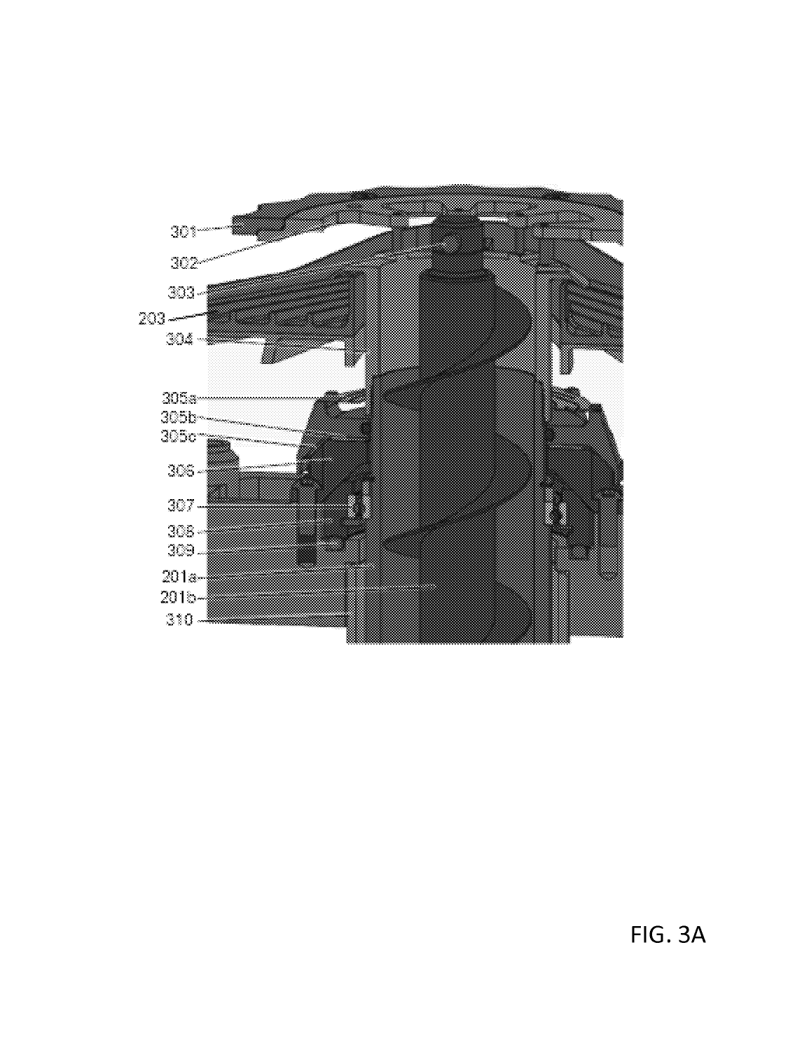

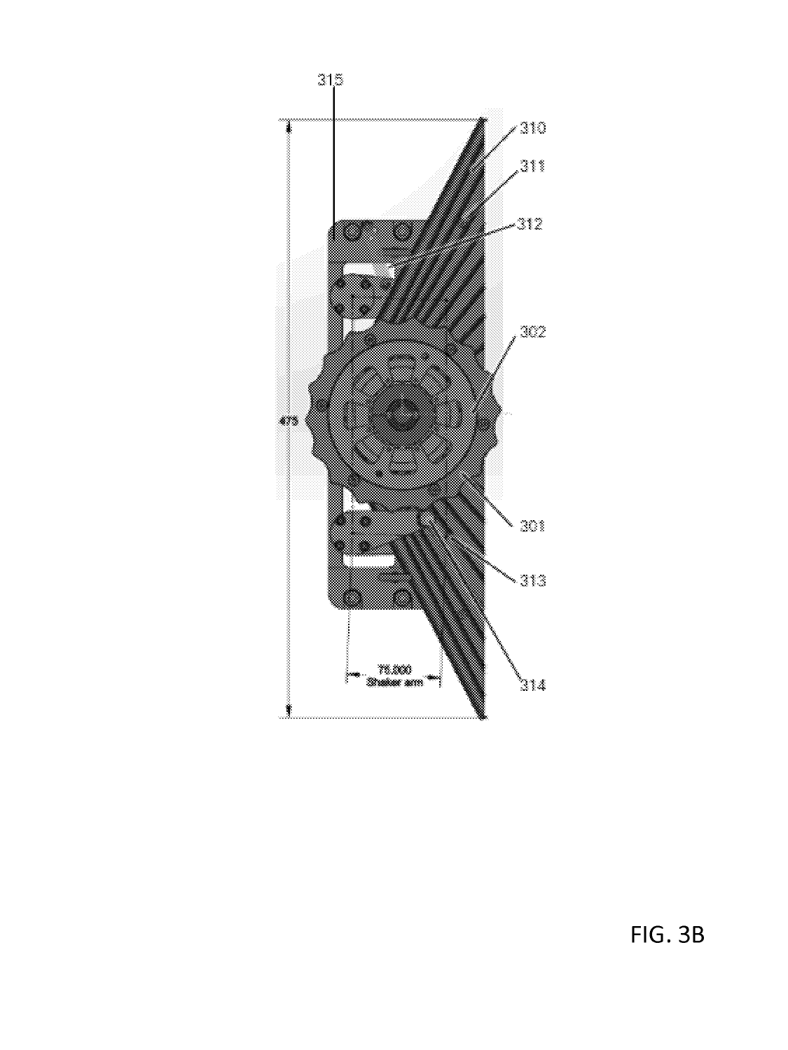

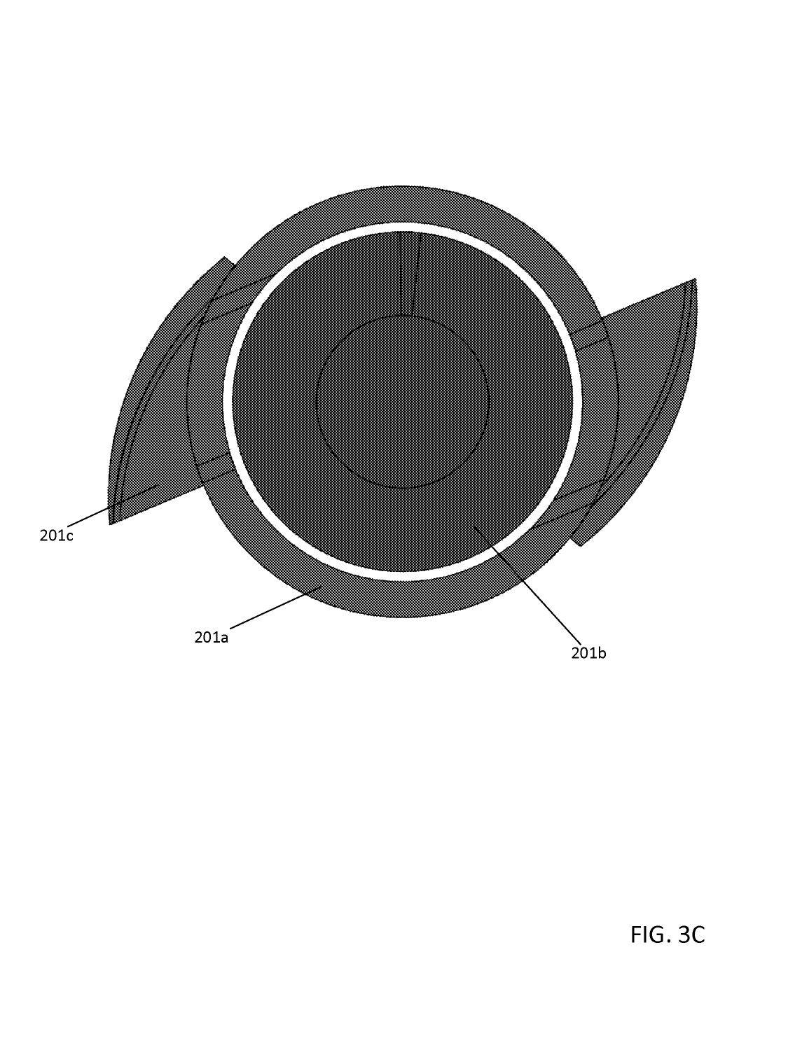

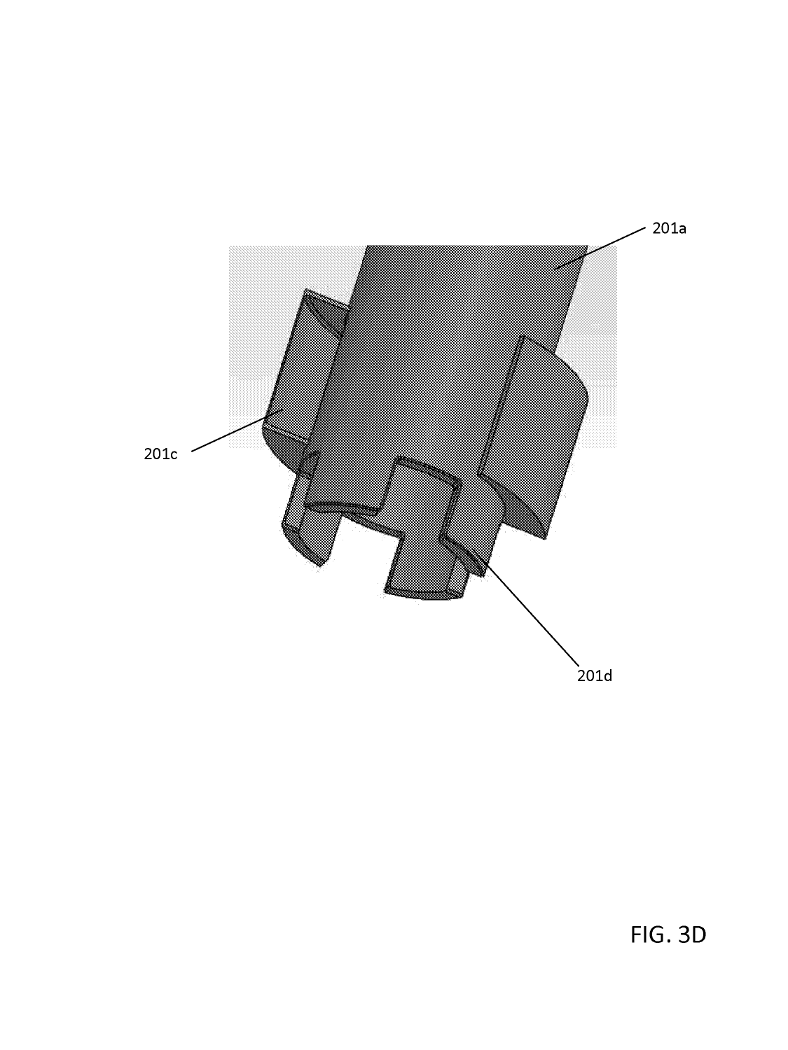

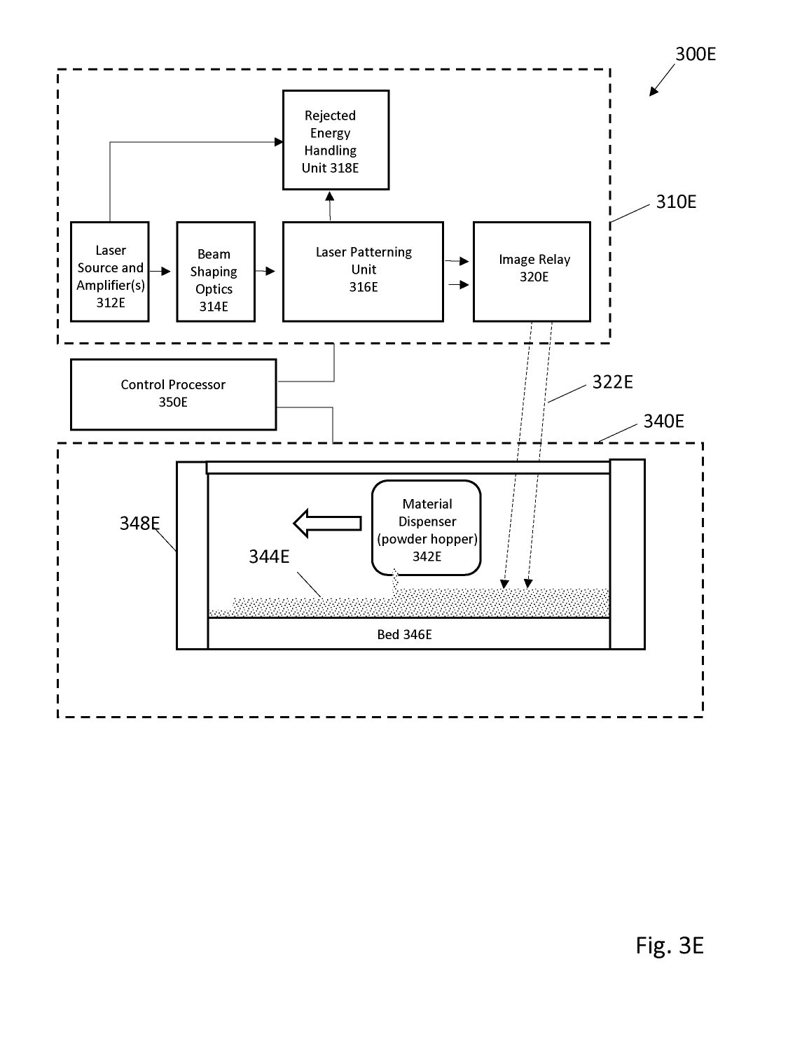

In some embodiments the auger 105 and the auger drive 106 could be replaced with an alternative powder conveyance mechanism including but not limited to airflow mechanisms, pressure differential mechanisms, or bucket conveyance mechanisms. In some embodiments the auger 105 has an exterior casing of auger 105 that can be rotated by the auger drive 106 independent of a central screw. Such an exterior casing may include intake areas which allow for precise intake of powder. In other embodiments the auger 105 can be formed to have a central screw that can be configured to rotate inside of a fixed exterior casing. In some embodiments the shuttle drive cylinder 103 and the auger drive 106 can include any motor configured to drive the movement of the shuttle and the auger 105. In some embodiments the bottom of the auger 105 is configured to couple to the powder hopper. In some embodiments the entire assembly can be configured to fit inside a closed environment configured to support an inert gas. As will be later described in more detail with respect to FIG. 3E, the inert gas can be any gas mixture comprising an amount of a noble gas or other inert gas.

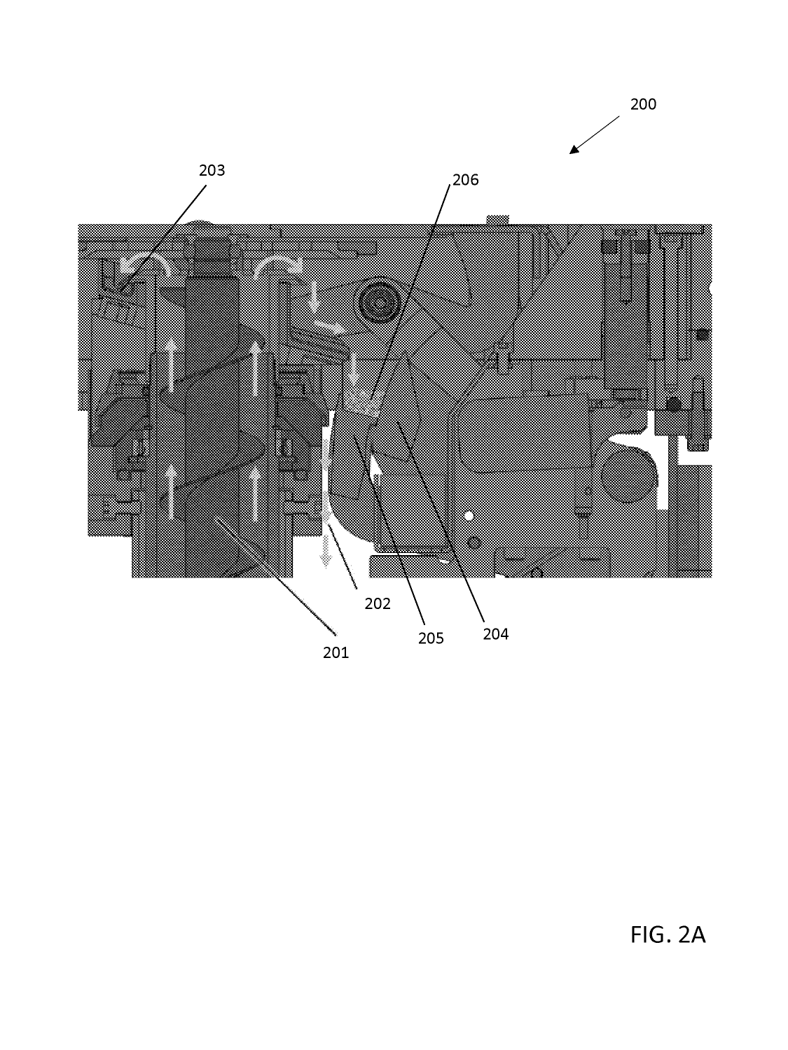

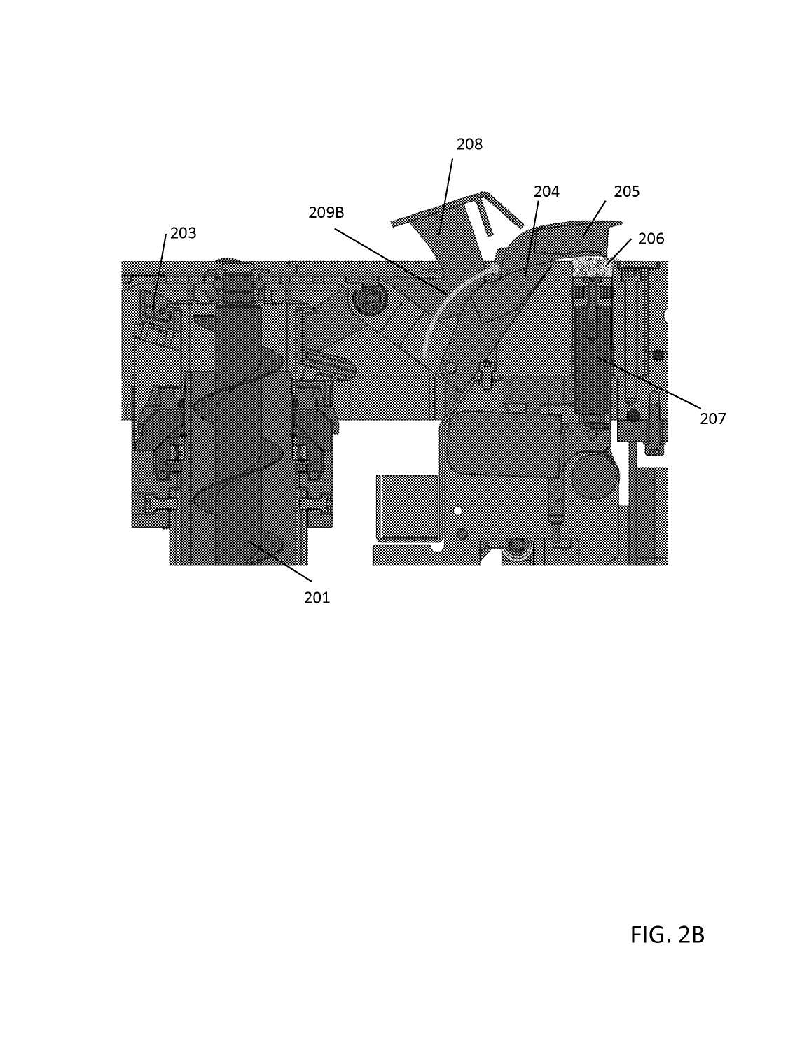

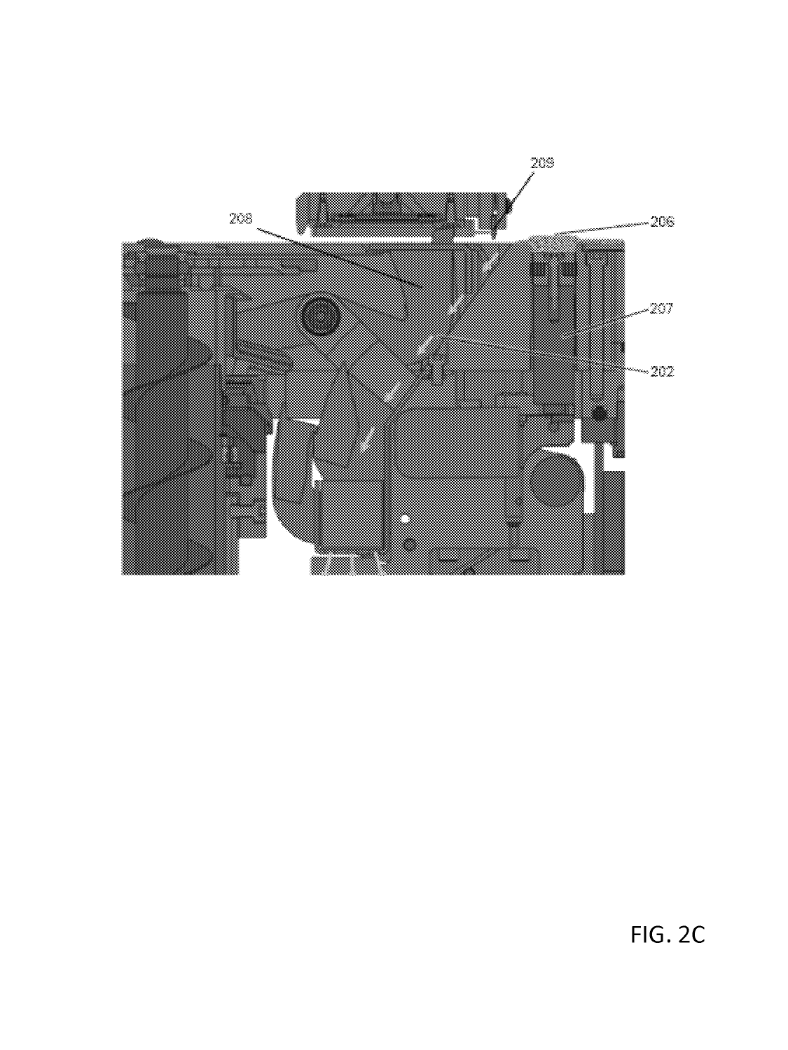

FIG. 2A illustrates a cross-sectional view of an embodiment 200 showing loading of the shuttle mechanism 102 such as illustrated with respect to FIG. 1 of the powder dispersion assembly 100. In FIG. 2A, powder 206 is conveyed from a powder hopper (not shown). In this embodiment, flow of the powder 206 through the system is indicated by arrows 202. The powder 206 is conveyed upwards from a powder hopper by auger 201. Once the powder 206 reaches the top of the auger 201, it can be fed to a powder dispersion plate 203. In some embodiments the powder dispersion plate 203 has one or more channels to aid in the even distribution of powder across the plate. The powder dispersion plate 203 can be configured to spread the powder 206 in an out of plane z-direction relative to FIG. 2A. The powder 206 can be conveyed onto a shuttle 102 that can include two parts, a carrier 204 and a pusher 205, configured to couple together after exiting the powder dispersion plate 203. In some embodiments the pusher 205 can further include a lip to enable the shuttle to hold a greater volume of powder 206. In some embodiments the pusher 205 can further include a cutout and the carrier 204 can further include a lip configured to couple to the ledge of the pusher 205 to form a shutoff configured to reduce powder lost during filling and translation of the shuttle. In some embodiments the pusher 205 and the carrier 204 can include hard anodized aluminum or a material with similar thermal resistive properties, ability to maintain such thermal resistive properties at high temperatures, and wear resistance. In some embodiments the pusher 205 can further include one or more vertical panels configured to separate sections of the pusher 205 for more uniform distribution of the powder 206 in the z-direction. In some embodiments the shuttle can be filled with less than one rotation of the auger 201. In some embodiments the system can be configured to capture the excess powder 206 that falls off the shuttle and reintroduce it into the powder hopper.

FIG. 2B illustrates a cross-sectional view of an alternative embodiment of the shuttle 102 of the powder dispersion assembly comprising a ram 207 configured to be loaded with powder 206. The shuttle can be configured to convey powder 206 to the ram 207. In some embodiments the carrier 204 of the shuttle 102 can be configured to rotate and couple to a wall of the ram 207 to form a seal to reduce powder 206 loss during conveyance. Additionally, in some embodiments the pusher 205 can be configured to rotate to a greater angle relative to the angle the carrier 204 so as to slide the powder 206 into the ram 207. In some embodiments the carrier 204 and the pusher 205 can be configured to maintain contact while translating rationally as indicated by the gray arrow 209B of FIG. 2B. In other embodiments the alternative embodiment of shuttle 102 can translate linearly. In some embodiments the assembly further includes a lid 208 coupled to the assembly and configured to open when the shuttle 102 conveys powder to the ram 207. In some embodiment the coupling is a hinged coupling. In other embodiments sliders or other couplings can be used. In some embodiments the ram 207 can be configured to translate vertically to adjust the amount of powder 206 dispersed in a given manufacturing cycle. In some embodiments the ram 207 can further include a hard stop to act as a point of maximum vertical retraction for the ram 207. In some embodiments the auger 201 can be configured to provide enough powder 206 to fill the ram 207 using as few as a fraction of a rotation of the auger 201.

FIG. 2C illustrates a cross-sectional view of an embodiment of the ram 207 conveying powder 206 towards the build plate and the spreader 209 subtractively measuring the amount of powder 206. In some embodiments the assembly further includes a spreader 209 that is configured to level out the powder 206. During the leveling out process, the assembly can be configured to allow for an excess of powder 206 to flow, as indicated by flow arrow 202, into the powder hopper for reuse. Additionally, in some embodiments once the powder 206 is loaded into the ram 206 the lid 208 can be configured to return to a closed position prior to spreading of the powder 206 using the spreader 209. In some embodiments wherein the ram 207 conveys powder using a positive displacement method the system can be enabled to minimize the elasticity problems that arise with other methods of powder distribution. In other embodiments the spreader 209 could include an electrostatic spreader or a spreader that uses selective airflow or blowing rather than a mechanical spreader as illustrated in FIG. 2C. In some embodiments friction can be used to hold the ram 206 in position when the spreader drives back off the ram activation lever. In some embodiments the ram 206 position can be controlled by a dedicated friction mechanism or using the ram powder seal for friction. In some embodiments the ram 206 can be counterbalanced so as to reduce the frictional force required to hold it in place.

FIG. 3A illustrates a cross-sectional view of an embodiment of the auger 201 and dispersion plate 101 connection. In some embodiments the auger 201 and dispersion plate 101 connection assembly can include a cam plate 301 coupled to a relief plate 302 configured to enable powder 206 to pass through it, an auger 201 with a central screw 201b configured to coaxially couple with a casing 201a and a casing sleeve 310, a weir 304 configured to coaxially couple to the casing 201a and configured to couple either directly or indirectly to a powder dispersion plate 203, an upper bearing seal configured to coaxially couple the casing 201a and the weir 304 comprising a felt preloaded spring 305a, a felt seal 305b, and an overhang 305c, a bearing housing 306 configured to couple to the upper bearing seal and the casing 201a, a casing bearing 307 coupled to a spherical element 308, and an O-ring 309 configured to couple to the spherical element 308. In some embodiments the weir 304 can be replaced with any powder 206 flow management mechanism. In some embodiments the central screw 201b can be configured to be held in place using a groove pin 303 configured to couple to the central screw 201b. In some embodiments the central screw 201b can be configured to rotate while the rotate as the casing 201a remains stationary to convey powder 206 upward. In other embodiments 201b can be configured to remain stationary while the casing 201a rotates to convey powder upward. In other embodiment both the casing 201a and the central screw 201b are configured to rotate in opposite directions to convey the powder 206. In other embodiments a conveyance mechanism other than an auger can be used. Additionally in some embodiments the upper bearing seal can increase the lifetime of the upper bearing. In some embodiments the overhang can be configured to rotate with the casing 201A as to improve the ability of the upper bearing seal to prevent powder 206 from entering the system. In some embodiments the size of the relief 302 can be adjusted to prevent jams and ensure uniform flow rates. In some embodiments, the assembly includes an olde auger and the casing 201a can be configured to rotate independent of the cam plate 301. In some embodiments of the assembly any juncture can further include a felt seal 305b configured to protect the bearings. Felt seal 305b can also help prevent powder entering the mechanism, reducing maintenance and increasing lifespan.

FIG. 3B illustrates a top view of an embodiment of the powder dispersion plate 203 and auger 201 connection. In some embodiments the powder dispersion plate can further include at least one channel 310. In some embodiments the channel 310 can have a downward angle “fall angle” to encourage efficient dispersion of the powder. In one example embodiment the fall angle can be 7 degrees, however, in other examples the fall angle may be greater. In some embodiments the assembly can further include a vibration mechanism coupled to the powder dispersion plate 203 configured to vibrate the powder dispersion plate 203. Vibrating the powder dispersion plate enables more uniform distribution of the powder across the channels. In some embodiments the vibration mechanism can be configured to vibrate at an amplitude and frequency depending on the powder characteristics including but not limited to density, powder diameter, and hardness. Additionally, in some embodiments the powder dispersion plate can vibrate at a given amplitude and frequency dependent on the fall angle of the channel. In some embodiments the vibration mechanism can vibrate at any combination of an amplitude ranging from 1-10mm and a frequency ranging from 1-60 Hz. In some embodiments the assembly can further include a spring 312 or other stabilizing mechanism coupled to the dispersion plate configured to reduce excess noise from the vibration mechanism In some embodiments the spring 312 can be configured to hold a follower arm against the cam plate 301. In some embodiments the spring 312 can be configured to couple to the frame 315. In some embodiments the powder dispersion plate 203 can further include a back lip to retain powder from the auger 201. In some embodiments the width of the channels 310 can vary between channels. In some embodiments the assembly can further include a follower 314 configured to couple to couple to the frame 315. In some embodiments the motion of the powder dispersion plate 203 can be defined by a linkage and driven by cam plate 301 via the rotating auger casing.

FIG. 3C illustrates a cross-sectional top view of an embodiment of the assembly comprising an auger wherein the auger is stationary, and the casing rotates around it. In some embodiments the casing 201a can further include an intake scoop 201c configured to convey powder 206 from the powder hopper into the auger 201. In some embodiments the intake scoop 201c can include an opening arranged to enable powder 206 to enter casing 201a. In some embodiments the casing 201a can include more than one intake scoop 201c. In some embodiments the intake scoop 201c can be oriented on different vertical planes.

FIG. 3D illustrates an embodiment of the carrier 201a of the auger configured to interact with a stationary screw 201b and an embodiment of the exterior casing 201a coupling a driving mechanism 106. In some embodiments the carrier 201a can further include drive teeth 201d configured to couple to the driving mechanism 106. In embodiments of casing 201a with drive teeth 201d the drive mechanism 106 can be any motor configured to generate rotational motion.

In an embodiment illustrated with respect to FIG. 3E, additive manufacturing systems including the described embodiments and powder spreading, dispersion and doping mechanisms can be represented by various modules that form additive manufacturing method and system 300E suitable for use in conjunction with powder dispensing systems described herein. As seen in FIG. 3E, a laser source and amplifier(s) 312 can be constructed as a continuous or pulsed laser. In other embodiments the laser source includes a pulse electrical signal source such as an arbitrary waveform generator or equivalent acting on a continuous-laser-source such as a laser diode. In some embodiments this could also be accomplished via a fiber laser or fiber launched laser source which is then modulated by an acousto-optic or electro optic modulator. In some embodiments a high repetition rate pulse source which uses a Pockels cell can be used to create an arbitrary length pulse train.

Possible laser types include, but are not limited to: Gas Lasers, Chemical Lasers, Dye Lasers, Metal Vapor Lasers, Solid State Lasers (e.g. fiber), Semiconductor (e.g. diode) Lasers, Free electron laser, Gas dynamic laser, "Nickel-like" Samarium laser, Raman laser, or Nuclear pumped laser.

A Gas Laser can include lasers such as a Helium–neon laser, Argon laser, Krypton laser, Xenon ion laser, Nitrogen laser, Carbon dioxide laser, Carbon monoxide laser or Excimer laser.

A Chemical laser can include lasers such as a Hydrogen fluoride laser, Deuterium fluoride laser, COIL (Chemical oxygen–iodine laser), or Agil (All gas-phase iodine laser).

A Metal Vapor Laser can include lasers such as a Helium–cadmium (HeCd) metal-vapor laser, Helium–mercury (HeHg) metal-vapor laser, Helium–selenium (HeSe) metal-vapor laser, Helium–silver (HeAg) metal-vapor laser, Strontium Vapor Laser, Neon–copper (NeCu) metal-vapor laser, Copper vapor laser, Gold vapor laser, or Manganese (Mn/MnCl2) vapor laser. Rubidium or other alkali metal vapor lasers can also be used. A Solid State Laser can include lasers such as a Ruby laser, Nd:YAG laser, NdCrYAG laser, Er:YAG laser, Neodymium YLF (Nd:YLF) solid-state laser, Neodymium doped Yttrium orthovanadate(Nd:YVO₄) laser, Neodymium doped yttrium calcium oxoborateNd:YCa4O(BO₃)3 or simply Nd:YCOB, Neodymium glass(Nd:Glass) laser, Titanium sapphire(Ti:sapphire) laser, Thulium YAG (Tm:YAG) laser, Ytterbium YAG (Yb:YAG) laser, Ytterbium:2O₃ (glass or ceramics) laser, Ytterbium doped glass laser (rod, plate/chip, and fiber), Holmium YAG (Ho:YAgG) laser, Chromium ZnSe (Cr:ZnSe) laser, Cerium doped lithium strontium (or calcium)aluminum fluoride(Ce:LiSAF, Ce:LiggCAF), Promethium 147 doped phosphate glass(147Pm+3:Glass) solid-state laser, Chromium doped chrysoberyl (alexandrite) laser, Erbium doped and erbium–ytterbium co-doped glass lasers, Trivalent uranium doped calcium fluoride (U:CaF₂) solid-state laser, Divalent samarium doped calcium fluoride(Sm:CaF₂) laser, or F-Center laser.

A Semiconductor Laser can include laser medium types such as GaN, InGaN, AlGaInP, AlGaAs, InGaAsP, GaInP, InGaAs, InGaAsO, GaInAsSb, lead salt, Vertical cavity surface emitting laser (VCSEL), Quantum cascade laser, Hybrid silicon laser, or combinations thereof.

As illustrated in FIG. 3E, the additive manufacturing system 300E uses lasers able to provide one- or two-dimensional directed energy as part of an energy patterning system 310E. In some embodiments, one dimensional patterning can be directed as linear or curved strips, as rastered lines, as spiral lines, or in any other suitable form. Two-dimensional patterning can include separated or overlapping tiles, or images with variations in laser intensity. Two-dimensional image patterns having non-square boundaries can be used, overlapping or interpenetrating images can be used, and images can be provided by two or more energy patterning systems. The energy patterning system 310E uses laser source and amplifier(s) 312E to direct one or more continuous or intermittent energy beam(s) toward beam shaping optics 314E. After shaping, if necessary, the beam is patterned by an energy patterning unit 316E, with generally some energy being directed to a rejected energy handling unit 318E. Patterned energy is relayed by image relay 320E toward an article processing unit 340E, in one embodiment as a two-dimensional image 322E focused near a bed 346E. The article processing unit 340E has plate or bed 346E (with walls 348E) that together form chamber containing material 344E (e.g. a metal powder) dispensed by powder hopper or other material dispenser 342E. Dispensed powder can be created or recycled as discussed in this disclosure. Patterned energy, directed by the image relay 320E, can melt, fuse, sinter, amalgamate, change crystal structure, influence stress patterns, or otherwise chemically or physically modify the dispensed and distributed material 344 to form structures with desired properties. A control processor 350E can be connected to variety of sensors, actuators, heating or cooling systems, monitors, and controllers to coordinate operation of the laser source and amplifier(s) 312E, beam shaping optics 314E, laser patterning unit 316E, and image relay 320E, as well as any other component of system 300E. As will be appreciated, connections can be wired or wireless, continuous or intermittent, and include capability for feedback (for example, thermal heating can be adjusted in response to sensed temperature).

In some embodiments, beam shaping optics 314E can include a great variety of imaging optics to combine, focus, diverge, reflect, refract, homogenize, adjust intensity, adjust frequency, or otherwise shape and direct one or more laser beams received from the laser source and amplifier(s) 312E toward the laser patterning unit 316E. In one embodiment, multiple light beams, each having a distinct light wavelength, can be combined using wavelength selective mirrors (e.g. dichroic) or diffractive elements. In other embodiments, multiple beams can be homogenized or combined using multifaceted mirrors, microlenses, and refractive or diffractive optical elements.

The laser patterning unit 316E can include static or dynamic energy patterning elements. For example, laser beams can be blocked by masks with fixed or movable elements. To increase flexibility and ease of image patterning, pixel addressable masking, image generation, or transmission can be used. In some embodiments, the laser patterning unit includes addressable light valves, alone or in conjunction with other patterning mechanisms to provide patterning. The light valves can be transmissive, reflective, or use a combination of transmissive and reflective elements. Patterns can be dynamically modified using electrical or optical addressing. In one embodiment, a transmissive optically addressed light valve acts to rotate polarization of light passing through the valve, with optically addressed pixels forming patterns defined by a light projection source. In another embodiment, a reflective optically addressed light valve includes a write beam for modifying polarization of a read beam. In certain embodiments, non-optically addressed light valves can be used. These can include but are not limited to electrically addressable pixel elements, movable mirror or micro-mirror systems, piezo or micro-actuated optical systems, fixed or movable masks, or shields, or any other conventional system able to provide high intensity light patterning.

Rejected energy handling unit 318E can be used to disperse, redirect, or utilize energy not patterned and passed through the image relay 320E. In one embodiment, the rejected energy handling unit 318E can include passive or active cooling elements that remove heat from both the laser source and amplifier(s) 312E and the laser patterning unit 316E. In other embodiments, the rejected energy handling unit can include a “beam dump” to absorb and convert to heat any beam energy not used in defining the laser pattern. In still other embodiments, rejected laser beam energy can be recycled using beam shaping optics 314E. Alternatively, or in addition, rejected beam energy can be directed to the article processing unit 340E for heating or further patterning. In certain embodiments, rejected beam energy can be directed to additional energy patterning systems or article processing units.

Image relay 320E can receive a patterned image (either one or two-dimensional) from the laser patterning unit 316E directly or through a switchyard and guide it toward the article processing unit 340E. The image relay can include telescope systems such as disclosed herein, as well as a range of other mirrors or optical elements.

The material dispenser 342E (e.g. powder hopper) in article processing unit 340E (e.g. cartridge) can distribute, remove, mix, provide gradations or changes in material type or particle size, or adjust layer thickness of material. The material can include metal, ceramic, glass, polymeric powders, other melt-able material capable of undergoing a thermally induced phase change from solid to liquid and back again, or combinations thereof. The material can further include composites of melt-able material and non-melt-able material where either or both components can be selectively targeted by the imaging relay system to melt the component that is melt-able, while either leaving along the non-melt-able material or causing it to undergo a vaporizing/destroying/combusting or otherwise destructive process. In certain embodiments, slurries, sprays, coatings, wires, strips, or sheets of materials can be used. Unwanted material can be removed for disposable or recycling by use of blowers, vacuum systems, sweeping, vibrating, shaking, tipping, or inversion of the bed 346E.

In addition to material handling components, the article processing unit 340E can include components for holding and supporting 3D structures, mechanisms for heating or cooling the chamber, auxiliary or supporting optics, and sensors and control mechanisms for monitoring or adjusting material or environmental conditions. The article processing unit can, in whole or in part, support a vacuum or inert gas atmosphere to reduce unwanted chemical interactions as well as to mitigate the risks of fire or explosion (especially with reactive metals). In some embodiments, various pure or mixtures of other atmospheres can be used, including those containing Ar, He, Ne, Kr, Xe, CO₂, N₂, O₂, SF₆, CH₄, CO, N₂O, C₂H₂, C₂H₄, C₂H₆, C₃H₆, C₃H₈, i-C₄H₁₀, C₄H₁₀, 1-C₄H₈, cic-2,C₄H₇, 1,3-C₄H₆, 1,2-C4H₆, C₅H₁₂, n-C₅H₁₂, i-C₅H₁₂, n-C₆H₁₄, C₂H₃Cl, C₇H₁₆, C₈H₁₈, C₁₀H₂₂, C₁₁H₂₄, C₁₂H₂₆, C₁₃H₂₈, C₁₄H₃₀, C₁₅H₃₂, C₁₆H₃₄, C₆H₆, C₆H₅-CH₃, C₈H₁₀, C₂H₅OH, CH₃OH, iC₄H₈. In some embodiments, refrigerants or large inert molecules (including but not limited to sulfur hexafluoride) can be used. An enclosure atmospheric composition to have at least about 1% He by volume (or number density), along with selected percentages of inert/non-reactive gases can be used.

In certain embodiments, a plurality of article processing units, cartridges, or build chambers, each having a build platform to hold a powder bed, can be used in conjunction with multiple optical-mechanical assemblies arranged to receive and direct the one or more incident energy beams into the cartridges. Multiple cartridges allow for concurrent printing of one or more print jobs.

In another embodiment, one or more article processing units, cartridges, or build chambers can have a cartridge that is maintained at a fixed height, while optics are vertically movable. A distance between final optics of a lens assembly and a top surface of powder bed a may be managed to be essentially constant by indexing final optics upwards, by a distance equivalent to a thickness of a powder layer, while keeping the build platform at a fixed height. Advantageously, as compared to a vertically moving the build platform, large and heavy objects can be more easily manufactured, since precise micron scale movements of the ever changing mass of the build platform are not needed. Typically, build chambers intended for metal powders with a volume more than ~ 0.1 – 0.2 cubic meters (i.e., greater than 100 – 200 liters or heavier than 500 – 1,000 kg) will most benefit from keeping the build platform at a fixed height.

In one embodiment, a portion of the layer of the powder bed in a cartridge may be selectively melted or fused to form one or more temporary walls out of the fused portion of the layer of the powder bed to contain another portion of the layer of the powder bed on the build platform. In selected embodiments, a fluid passageway can be formed in the one or more first walls to enable improved thermal management.

In some embodiments, the additive manufacturing system can include article processing units or cartridges that support a powder bed capable of tilting, inverting, and shaking to separate the powder bed substantially from the build platform in a hopper. The powdered material forming the powder bed may be collected in a hopper for reuse in later print jobs. The powder collecting process may be automated and vacuuming or gas jet systems can also be used to aid powder dislodgement and removal.

Some embodiments, the additive manufacturing system can be configured to easily handle parts longer than an available build chamber or cartridge. A continuous (long) part can be sequentially advanced in a longitudinal direction from a first zone to a second zone. In the first zone, selected granules of a granular material can be amalgamated. In the second zone, unamalgamated granules of the granular material can be removed. The first portion of the continuous part can be advanced from the second zone to a third zone, while a last portion of the continuous part is formed within the first zone and the first portion is maintained in the same position in the lateral and transverse directions that the first portion occupied within the first zone and the second zone. In effect, additive manufacture and clean-up (e.g., separation and/or reclamation of unused or unamalgamated granular material) may be performed in parallel (i.e., at the same time) at different locations or zones on a part conveyor, with no need to stop for removal of granular material and/or parts.

In another embodiment, additive manufacturing capability can be improved by use of an enclosure restricting an exchange of gaseous matter between an interior of the enclosure and an exterior of the enclosure. An airlock provides an interface between the interior and the exterior; with the interior having multiple additive manufacturing chambers, including those supporting power bed fusion. A gas management system maintains gaseous oxygen within the interior at or below a limiting oxygen concentration, increasing flexibility in types of powder and processing that can be used in the system.

In another manufacturing embodiment, capability can be improved by having a article processing units, cartridges, or build chamber contained within an enclosure, the build chamber being able to create a part having a weight greater than or equal to 2,000 kilograms. A gas management system may maintain gaseous oxygen within the enclosure at concentrations below the atmospheric level. In some embodiments, a wheeled vehicle may transport the part from inside the enclosure, through an airlock, since the airlock operates to buffer between a gaseous environment within the enclosure and a gaseous environment outside the enclosure, and to a location exterior to both the enclosure and the airlock.

Other manufacturing embodiments involve collecting powder samples in real-time from the powder bed. An ingester system is used for in-process collection and characterizations of powder samples. The collection may be performed periodically and the results of characterizations result in adjustments to the powder bed fusion process. The ingester system can optionally be used for one or more of audit, process adjustments or actions such as modifying printer parameters or verifying proper use of licensed powder materials.

Yet another improvement to an additive manufacturing process can be provided by use of a manipulator device such as a crane, lifting gantry, robot arm, or similar that allows for the manipulation of parts that can be difficult or impossible for a human to move is described. The manipulator device can grasp various permanent or temporary additively manufactured manipulation points on a part to enable repositioning or maneuvering of the part.

Control processor 350E can be connected to control any components of additive manufacturing system 300E described herein, including lasers, laser amplifiers, optics, heat control, build chambers, and manipulator devices. The control processor 350E can be connected to a variety of sensors, actuators, heating or cooling systems, monitors, and controllers to coordinate operation. A wide range of sensors, including imagers, light intensity monitors, thermal, pressure, or gas sensors can be used to provide information used in control or monitoring. The control processor can be a single central controller, or alternatively, can include one or more independent control systems. The controller processor 350E is provided with an interface to allow input of manufacturing instructions. Use of a wide range of sensors allows various feedback control mechanisms that improve quality, manufacturing throughput, and energy efficiency.

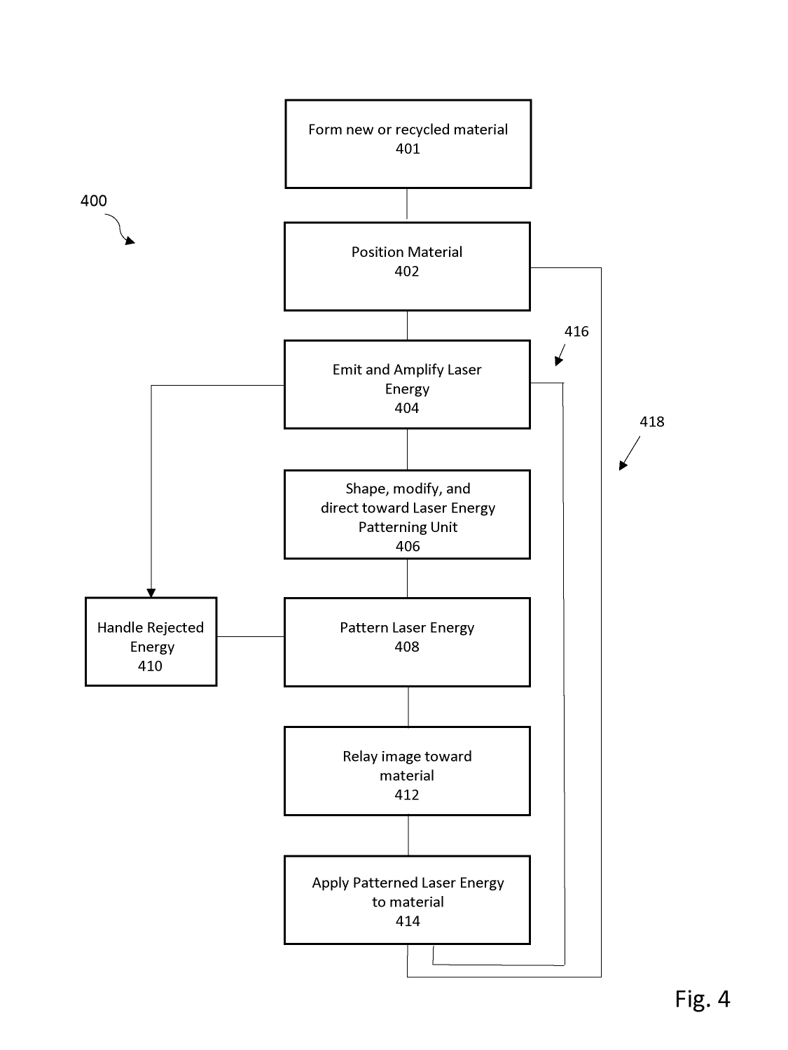

One embodiment of operation of a manufacturing system suitable for additive or subtractive manufacture is illustrated in FIG. 4. In this embodiment, a flow chart 400 illustrates one embodiment of a manufacturing process supported by the described optical and mechanical components. In step 401, material powder created or recycled as discussed in this disclosure is formed. In step 402, the powder material is positioned in a cartridge, bed, chamber, or other suitable support. In some embodiments, the material can be a metal plate for laser cutting using subtractive manufacture techniques, or a powder capable of being melted, fused, sintered, induced to change crystal structure, have stress patterns influenced, or otherwise chemically or physically modified by additive manufacturing techniques to form structures with desired properties.

In step 404, unpatterned laser energy is emitted by one or more energy emitters, including but not limited to solid state or semiconductor lasers, and then amplified by one or more laser amplifiers. In step 406, the unpatterned laser energy is shaped and modified (e.g. intensity modulated or focused). In step 408, this unpatterned laser energy is patterned, with energy not forming a part of the pattern being handled in step 410 (this can include conversion to waste heat, recycling as patterned or unpatterned energy, or waste heat generated by cooling the laser amplifiers in step 404). In step 412, the patterned energy, now forming a one or two-dimensional image is relayed toward the material. In step 414, the image is applied to the material, either subtractively processing or additively building a portion of a 3D structure. For additive manufacturing, these steps can be repeated (loop 418) until the image (or different and subsequent image) has been applied to all necessary regions of a top layer of the material. When application of energy to the top layer of the material is finished, a new layer can be applied (loop 416) to continue building the 3D structure. These process loops are continued until the 3D structure is complete, when remaining excess material can be removed or recycled.

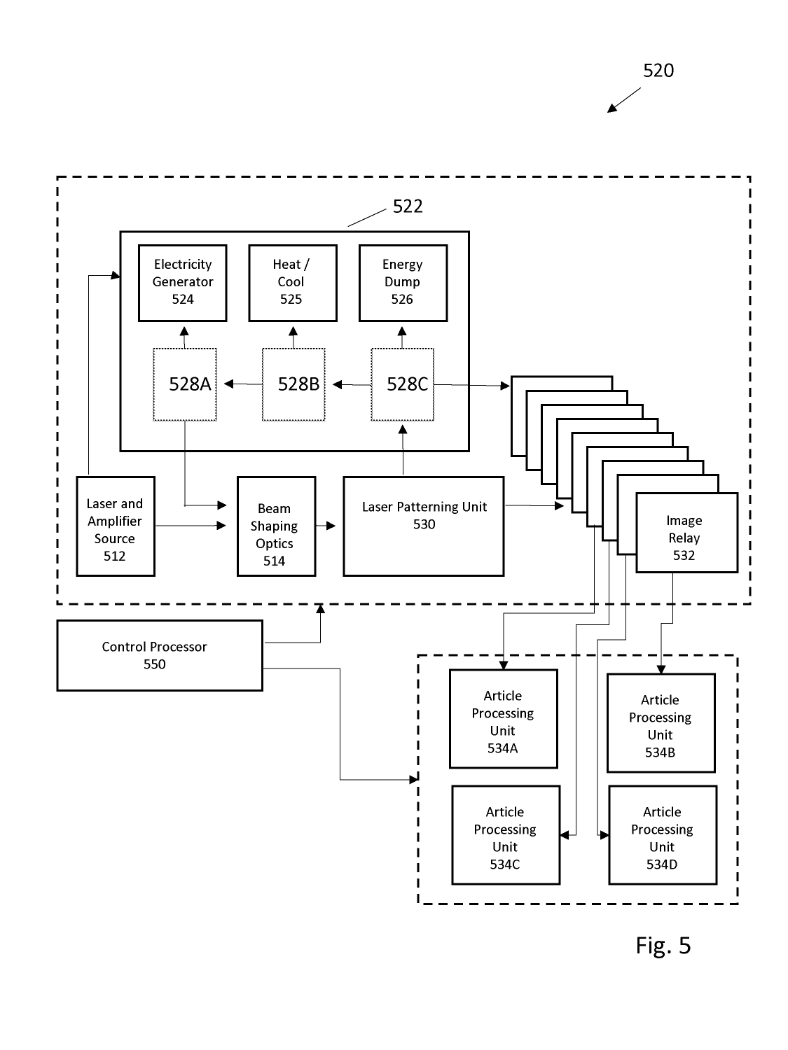

FIG. 5 is one embodiment of an additive manufacturing system that includes a light valve and a switchyard system enabling reuse of patterned two-dimensional energy. Switchyard systems are suitable for reducing the light wasted in the additive manufacturing system as caused by rejection of unwanted light due to the pattern to be printed. A switchyard involves redirections of a complex pattern from its generation (in this case, a plane whereupon a spatial pattern is imparted to structured or unstructured beam) to its delivery through a series of switch points. Each switch point can optionally modify the spatial profile of the incident beam. The switchyard optical system may be utilized in, for example and not limited to, laser-based additive manufacturing techniques where a mask is applied to the light. Advantageously, in various embodiments in accordance with the present disclosure, the thrown-away energy may be recycled in either a homogenized form or as a patterned light that is used to maintain high power efficiency or high throughput rates. Moreover, the thrown-away energy can be recycled and reused to increase intensity to print more difficult materials. In this embodiment, an additive manufacturing system 520 has an energy patterning system with a laser and amplifier source 512 that directs one or more continuous or intermittent laser beam(s) toward beam shaping optics 514. Excess heat can be transferred into a rejected energy handling unit 522 that can include an active light valve cooling system. After shaping, the beam is two-dimensionally patterned by an energy patterning unit 530, with generally some energy being directed to the rejected energy handling unit 522. Patterned energy is relayed by one of multiple image relays 532 toward one or more article processing units 534A, 534B, 534C, or 534D, typically as a two-dimensional image focused near a movable or fixed height bed. The bed can optionally be inside a cartridge that includes a powder hopper or similar material dispenser. Patterned laser beams, directed by the image relays 532, can melt, fuse, sinter, amalgamate, change crystal structure, influence stress patterns, or otherwise chemically or physically modify the dispensed material to form structures with desired properties.

In this embodiment, the rejected energy handling unit has multiple components to permit reuse of rejected patterned energy. Coolant fluid from the laser amplifier and source 512 can be directed into one or more of an electricity generator 524, a heat/cool thermal management system 525, or an energy dump 526. Additionally, relays 528A, 528B, and 528C can respectively transfer energy to the electricity generator 524, the heat/cool thermal management system 525, or the energy dump 526. Optionally, relay 528C can direct patterned energy into the image relay 532 for further processing. In other embodiments, patterned energy can be directed by relay 528C, to relay 528B and 528A for insertion into the laser beam(s) provided by laser and amplifier source 512. Reuse of patterned images is also possible using image relay 532. Images can be redirected, inverted, mirrored, sub-patterned, or otherwise transformed for distribution to one or more article processing units 534A-D. Advantageously, reuse of the patterned light can improve energy efficiency of the additive manufacturing process, and in some cases improve energy intensity directed at a bed or reduce manufacture time.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims. It is also understood that other embodiments of this invention may be practiced in the absence of an element/step not specifically disclosed herein.

1. A powder dispersion assembly for a print cartridge comprising:
a powder hopper configured to contain a powder below a print plate;
a conveyance mechanism;
and a powder dispersion mechanism coupled to the conveyance mechanism; wherein,
the conveyance mechanism is configured to covey the powder from the powder hopper;
and,
the powder dispersion mechanism is configured to receive powder from the conveyance mechanism and disperse powder onto the print cartridge.

2. The powder dispersion assembly of claim 1 wherein the conveyance mechanism is an auger.

3. The powder dispersion assembly of claim 2 wherein the auger is has a fixed central screw and a rotatable exterior casing.

4. The powder dispersion assembly of claim 1 wherein the powder dispersion plate is configured to couple to a vibration mechanism.

5. The powder dispersion assembly of claim 1 wherein the powder conveyance mechanism further comprises a shuttle with a shutoff feature configured to convey powder to a load ram.

6. The powder dispersion assembly of claim 1 wherein the powder dispersion plate further comprises at least one channel configured to convey the powder.

7. The powder dispersion assembly of claim 1 further comprising a bearing with an overhang configured to couple the powder conveyance mechanism to the powder dispersion plate.

8. The powder dispersion assembly of claim 1 wherein the powder hopper is configured below the powder dispersion plate.

9. The powder dispersion assembly of claim 1 further comprising a mechanism configured to spread powder.

10. A method of powder conveyance comprising:
providing a powder from a powder hopper to a powder dispersion plate above the powder hopper;
dispersing the powder to a conveyance using the powder dispersion plate;
conveying the powder to a build plate; and
measuring an amount of powder onto build plate.

11. The method of claim 10 wherein conveying the powder to a build plate further comprises loading a shuttle configured to convey the powder to a ram configured to convey the powder to a build plate.

12. The method of claim 10 wherein measuring of an amount of powder comprises a positive displacement of powder followed by a subtractive measuring method.

13. The method of claim 10 further comprising vibrating the powder dispersion plate.

14. The method of claim 10 further comprising collecting excess powder.

15. The method of claim 14 further comprising combining the excess powder with the powder from the powder hopper.

16. The powder dispersion assembly of claim 1 further comprising a subtractive measurement system configured to interact with the powder conveyed to the print cartridge.

17. The powder dispersion assembly of claim 1 wherein an overflow powder is configured to be recirculated into the powder hopper.

18. The powder dispersion assembly of claim 1 wherein the assembly is configured to accommodate a powder bed fusion manufacturing assembly.

19. The method of claim 10 wherein powder is used in powder bed fusion manufacturing.

20. A powder dispersion assembly for a print cartridge comprising:
a powder hopper;
a conveyance mechanism;
a powder dispersion mechanism coupled to the conveyance mechanism to convey the powder from the powder hopper; wherein the powder dispersion mechanism is configured to receive powder from the conveyance mechanism and disperse powder onto the print cartridge.
